(19) United States
(12) Patent Application Publication
(10) Pub. No.: US 2008/0014384 A1
(43) Pub. Date: Jan. 17, 2008

(54) Spice bottle

(76) Inventor: Ming-Kuei Lin, Panchiao City (TW)

Correspondence Address: TROXELL LAW OFFICE PLLC, SUITE 1404, 5205 LEESBURG PIKE, FALLS CHURCH, VA, 22041, US

(21) Appl. No.: 11/484,675

(22) Filed: Jul. 12, 2006

(51) Int. Cl. B31B 45/00

(52) U.S. Cl. 428/34.1

(57) ABSTRACT

A spice bottle includes a spice container, a transparent liquid container and an container for electronic parts. The spice container is disposed on upper part of the spice bottle with holes facing upwards. The transparent liquid container is filled with transparent liquid with a plurality of differently colored lustrous foil fragments flowing therein for display. The container for electronic parts is disposed with a circuit board, a battery holder, a vibration switch and a plurality of LED (light-emitting diode) lamps. Light emitted from the LED lamps illuminates into the transparent liquid container. When the spice bottle is shaken for pouring spices out, the lustrous foil fragments inside the transparent liquid container is simultaneously driven to flow freely. At the same time, the LED lamps are turned on by the vibration switch for emitting light into the transparent liquid container so as to show dynamic lighting effect caused by reflection of the lustrous foil fragments.

### BACKGROUND OF THE INVENTION

The present invention relates to a spice bottle, especially to a spice bottle combines a transparent liquid container and a container for electronic parts. By shaking the spice bottle, the foil fragments in liquid generates reflective lighting and dynamic effect.

Lamps with liquid and lustrous foil fragments are prior arts. Refer to U.S. Pat. No. 6,309,084 B1, a conventional lamp showing floating and lustrous foil fragments is disclosed in FIG. 1. The lamp consists of a light bulb that generates heat and a transparent container. A low-boiling-point clear liquid with a plurality of differently colored lustrous foil fragments is filled inside the transparent container. In usage, the light bulb illuminates toward the transparent container. Heat generating from the bulb causes convection in liquid so as to make the lustrous foil fragments flow upwards or downwards freely for dynamic effects. However, conventional lamp with 1 lustrous foil fragments uses heat from the light bulb as a driving force, this consumes a lot of power and thus batteries can't provide enough power. Moreover, it can use as a lamp without any other uses or applications. Furthermore, spice bottles on table for keeping salt/pepper are used according to users' needs. By shaking, spices falls on food from a plurality of holes on the spice bottles. However, such kind of spice bottles are only used as containers without any other added value such as special effect lighting. Thus such spice bottles lack novelty and decorative effect.

### SUMMARY OF THE INVENTION

Therefore it is a primary object of the present invention to provide a spice bottle composed of a spice container, a transparent liquid container and an container for electronic parts. The spice container is disposed on upper part of the spice bottle so as to sprinkle spices from holes on top side while the transparent liquid container is filled with transparent liquid and a plurality of differently colored lustrous foil fragments floating inside the liquid. The container for electronic parts is arranged with a circuit board, a battery holder, vibration switch and a plurality of LED (light-emitting diode) lamps. Light emitted from the LED lamps illuminates into the transparent liquid container. Thus while shaking the spice bottle for adding spices on food, the lustrous foil fragments floating inside the transparent liquid container is driven to flow freely by the shaking force. At the same time, the LED lamps are turned on by vibration switch so as to illuminate light into the transparent liquid container. Thus the lustrous foil fragments reflects the light to have dynamic lighting effect. Therefore, the spice bottle is added with novelty and decorative effect.

### BRIEF DESCRIPTION OF THE DRAWINGS

FIG. 1 is a perspective view of an embodiment according to the present invention;

FIG. 2 is a lateral cross-sectional view of the embodiment in FIG. 1;

FIG. 3 is a perspective view of another embodiment according to the present invention;

FIG. 4 is a lateral cross-sectional view of the embodiment in FIG. 3;

FIG. 5 is a perspective view of a further embodiment according to the present invention;

FIG. 6 is a lateral cross-sectional view of the embodiment in FIG. 5.

### DETAILED DESCRIPTION OF THE PREFERRED EMBODIMENT

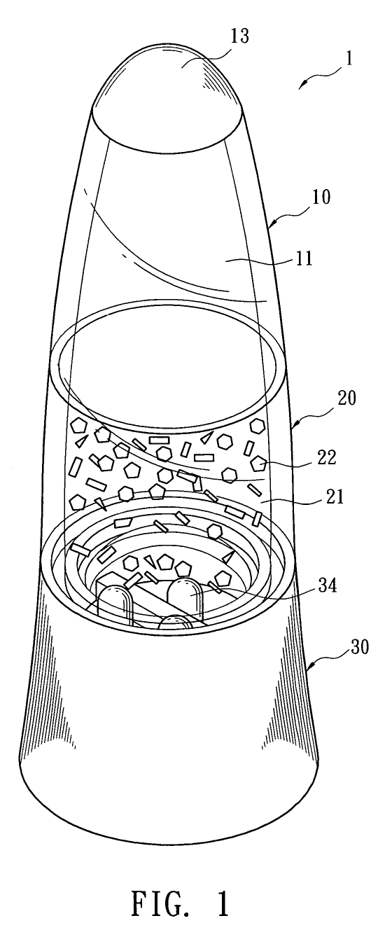

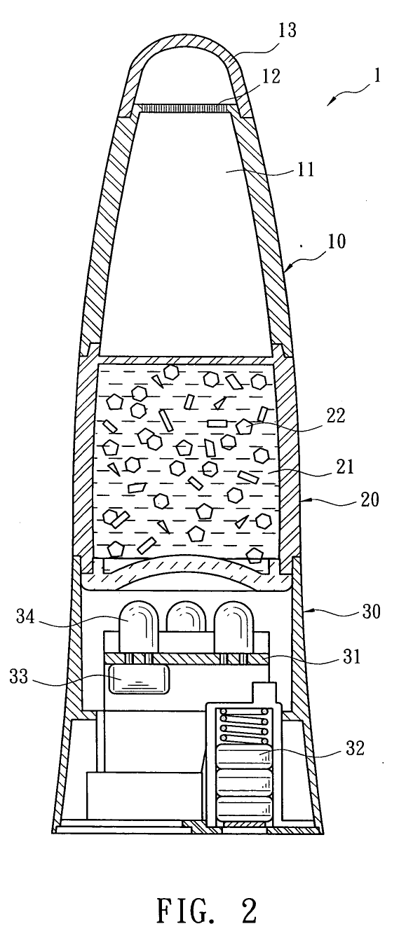

Refer to FIG. 1 & FIG. 2, a spice bottle 1 according to the present invention consists of a spice container 10, a transparent liquid container 20 and an container for electronic parts 30. The spice container 10 is disposed on upper part of the spice bottle 1 and an inner space 11 thereof is for filling spices such as salt or pepper that is used often on table. Holes for pouring spices disposed on top of the a spice container 10 and a cap 13 may arranged on the holes 12. The transparent liquid container 20 is a closed container for liquid and is arranged under the spice container 10. Transparent liquid 21 is filled inside the transparent liquid container 20 and a plurality of differently colored lustrous foil fragments flows inside the liquid 21, being displayed through a transparent housing of the liquid container. The container for electronic parts 30 including a circuit board 31, a battery holder 32, a vibration switch 33 and a plurality of LED lamps 34 is arranged on bottom of the transparent liquid container 20. Light emitted from the LED lamps 34 illuminates into the transparent liquid container 20 through the bottom plane of the transparent liquid container 20. There are no limits on numbers and colors of the LED lamps 34 and there are various designs of illumination pattern of the LEDs according to the circuit board 31. The lighting pattern can be set in general or cross. Or the period of luminance of the LED light is from one to three minutes and then stops automatically in accordance with the flowing of the lustrous foil fragments 22. And the vibration switch 33 is a conventional electronic technique and is not described in details.

In usage, when users pick up the spice bottle 1 and shake it for pouring spices on food through the holes 12, the colored lustrous foil fragments 22 in the liquid 21 inside the transparent liquid container 20 also flows freely. The LED lamps 34 are simultaneously turned on by the vibration switch 24 so as to make light emit from LED lamps into the transparent liquid container 20 through the bottom side of the transparent liquid container 20. By reflective lighting and shadow of the lustrous foil fragments 22, the device generates dynamic lighting effect. Moreover, the LED lamps 34 save power and generate no heat. Thus the light source is more power-saving and safe.

Furthermore, density of the lustrous foil fragments 22 according to the present invention can be controlled during manufacturing processes. Thus while shaking the spice bottle 1, the lustrous foil fragments 22 keeps flowing for a while and then floats to liquid surface, sinks into the bottom or suspends in the liquid 21, depending on its density. In other words, the dynamic lighting effect generated by reflective lighting and shadows of the lustrous foil fragments 22 lasts a period of time such as 1 to 3 minutes.

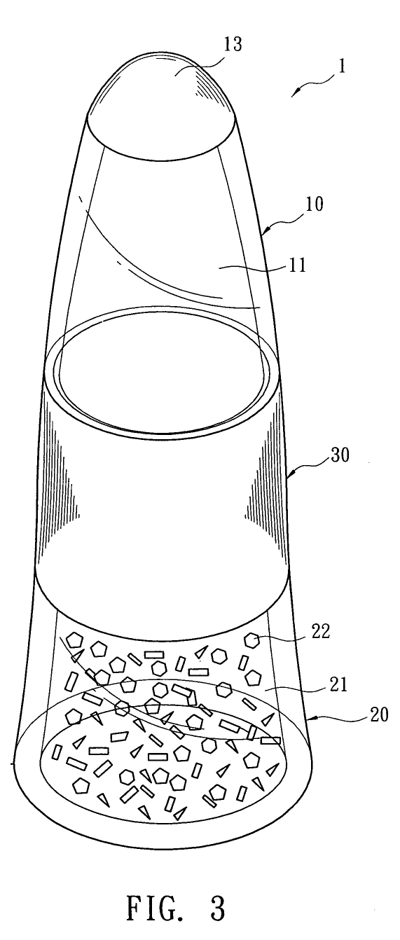

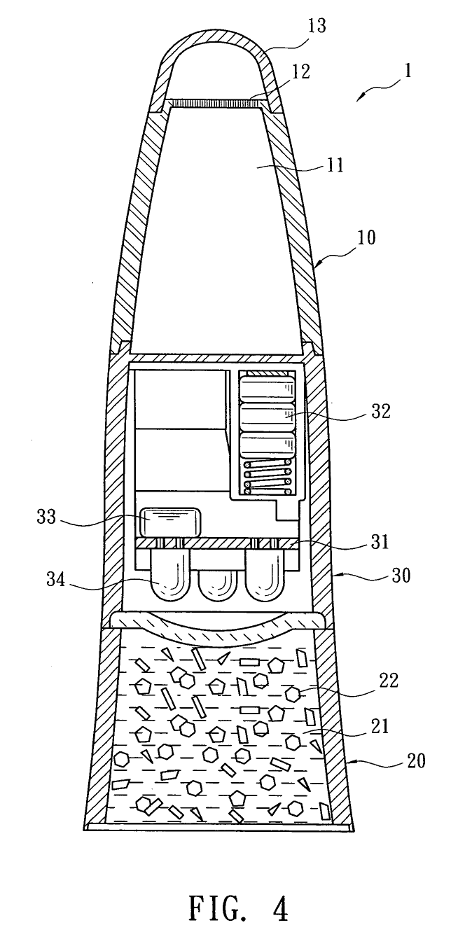

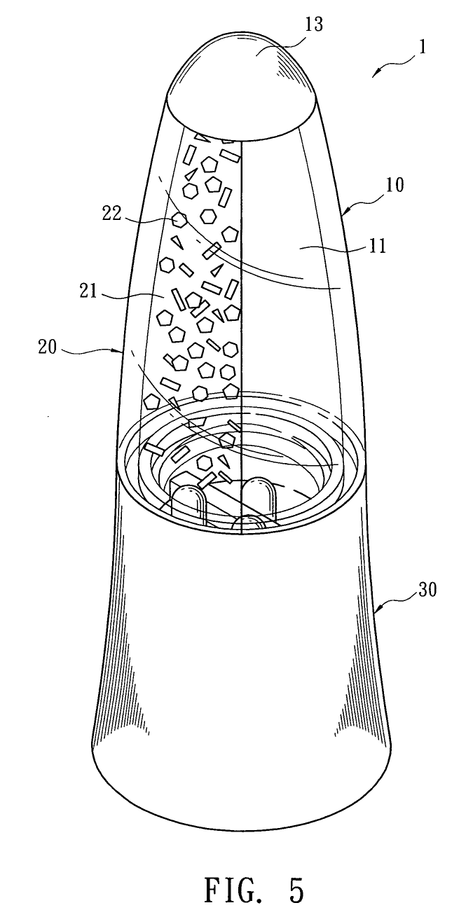

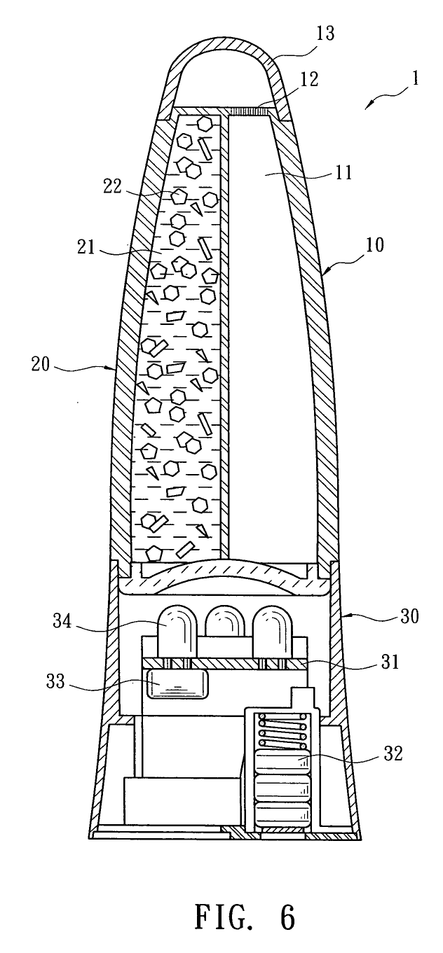

There is no limit on appearance of the spice bottle 1 of the present invention. Also shapes of the spice container 10, the transparent liquid container 20 and the container for electronic parts 30 and the way connecting them are not restricted. The positions of the three parts can be adjusted, as shown in FIG. 3 & FIG. 4. The spice container 10 is still located on upper part of the spice bottle 1 but the container for electronic parts 30 is mounted on bottom of the spice container 10 and transparent liquid container 20 is under the container for electronic parts 30. Thus light emitted from several LED lamps 34 illuminates into the transparent liquid container 20 through top surface of the transparent liquid container 20. Refer to FIG. 5 & FIG. 6, the spice container 10 is still located on upper part of the spice bottle 1 yet the transparent liquid container 20 is arranged on side of the spice container 10, in parallel with the spice container 10. Then the container for electronic parts 30 is disposed on bottom of the spice container 10 and the transparent liquid container 20. Thus light emitted from several LED lamps 34 illuminates into the transparent liquid container 20 through bottom surface of the transparent liquid container 20.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A spice bottle comprising a spice container, a transparent liquid container and an container for electronic parts;
the spice container having holes and inner space is disposed on upper part of the spice bottle; the holes face upwards while the inner space is for accommodation of spices;
the transparent liquid container filled with transparent liquid with a plurality of differently colored lustrous foil fragments flowing inside the liquid; the foil fragments are displayed through a transparent housing of the transparent liquid container;
the container for electronic parts is arranged with a circuit board, a battery holder, a vibration switch and a plurality of LED (light-emitting diode) lamps; the LED lamps are turned on or off by the vibration switch and light emitted from the LED lamps illuminates into the transparent liquid container;
thereby while shaking the spice bottle, the colored lustrous foil fragments floating inside the transparent liquid container simultaneously begins to flow freely and the LED lamps are turned on by the vibration switch at the same time so as to have dynamic lighting effect generated by reflection of the lustrous foil fragments.

2. The device as claimed in claim 1, wherein the transparent liquid container is disposed under the spice container and the container for electronic parts is arranged under the transparent liquid container while light from the LED lamps illuminates into the transparent liquid container through the bottom surface of the transparent liquid container.

3. The device as claimed in claim 1, wherein the container for electronic parts is arranged under spice container and the transparent liquid container is disposed under the container for electronic parts while light from the LED lamps illuminates into the transparent liquid container through the top surface of the transparent liquid container.

4. The device as claimed in claim 1, wherein the transparent liquid container is arranged on side of the spice container, in parallel with each other, while the container for electronic parts is disposed on bottom of the transparent liquid container as well as the spice container; light from the LED lamps illuminates into the transparent liquid container through bottom surface of the transparent liquid container.

5. The device as claimed in claim 1, wherein number and color of the LED lamps are not restricted.

6. The device as claimed in claim 1, wherein the LED lamps blink.

7. The device as claimed in claim 1, wherein the LED lamps is set to illuminate for a period of time and then stops lighting automatically.

8. The device as claimed in claim 1, wherein the spices include salt or pepper.
